(19) United States
(12) Patent Application Publication
(10) Pub. No.: US 2006/0028812 A1
(43) Pub. Date: Feb. 9, 2006

(54) Rechargeable halogen searcheye

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/059,219

(22) Filed: Feb. 16, 2005

(30) Foreign Application Priority Data
Aug. 5, 2004 (CN) 2004100705047

(51) Int. Cl. F21L 4/00

(52) U.S. Cl. 362/184; 362/183; 362/294; 362/390

(57) ABSTRACT

The present invention is relates to a rechargeable halogen search light and more particularly, to a rechargeable halogen search light which is having four sources of lights, whereas, one of the lighting sources is a SOS signal flash light source and equipped with an adjustable handle, wherein said flashing light source can emit 300 continuing hours of flashing signals; one of the light source is a spotlight, another light source is a clod-cathode light which can emit lights for at least 15,000 hours continuously. The present invention is an important source of light used in marine, army, public security, firefighting, emergency treatment, disciplined troop, architecture and civil vessels, as well as emergency treatment in daily life.

### BACKGROUND OF SAID PRESENT INVENTION

1. Field of Invention

The present invention is relates to a rechargeable halogen search light and more particularly, to a rechargeable halogen search light which is having four sources of lights, whereas, one of the lighting sources is a SOS signal flash light source and equipped with an adjustable handle, wherein said flashing light source can emit 300 continuing hours of flashing signals; one of the light source is a spotlight, another light source is a clod-cathode light which can emit lights for at least 15,000 hours continuously.

2. Description of Related Arts

Military, law enforcement, fire and rescue personnel, security personnel, hunters and recreational boaters among others for nighttime surveillance in any application commonly use handheld halogen searchlights, where a high intensity spotlight is required. Nowadays, such application is highly demeaned in all anti-terrorists actions that take place at nighttime. Conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

### SUMMARY OF SAID PRESENT INVENTION

The main object of the present invention is to provide a rechargeable halogen search light having an ability to have at least three light sources.

Another object of the present invention is to provide a rechargeable halogen search light having a movable handle equipped with an adjustable light source which has an ability to rotate and/or to move any angles within 90 degree circular arc.

Another object of the present invention is to provide a rechargeable halogen search light having an ability to adopt difference power source supplies.

Another object of the present invention is provide a rechargeable halogen search light having four sources of lighting enable extra strength of lights.

Accordingly, to achieve the above objects, a rechargeable compact fluorescent comprises:
a three-dimensional rectangular-cylinder housing, inside of it contains at least four sources of lighting wherein one of said sources of lighting is a spotlight, power saving illuminants; and
one of said sources of lights is a SOS flashlight source, and
one of said sources of lights is another spotlight, and
one of said source of lights is a cold-cathode light, and
a plurality of reflector is fixed around said mean of light source; and
a transparent front flat board; and
a plurality of heat release covers attached at the end portion of said housing; and
a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut.
It is made of soft material to prevent said rechargeable halogen lantern from shocks or quakes when excessive external force applied to it; and
a plurality of an movable handle with a pre-determined adjustable degree mobility, which can provide an ability to rotate and/or to move any angles within 90 degree circular arc so as to provide the best angle of lighting according to appropriated situation.

On the other hand, the present invention has a rotating clip which allows connection to the joint axle at the end of the flexible hand grip, a flange component at the outside of the illuminant, and a switch button. The said joint axle connects the flexible hand grip with the flange component, and rotates around the flange part. There is a square groove at one end of the flange component. Inside the flexible hand grip opposite to the square groove, there is a square groove of the same size. The said switch hand grip has a square pivot arm, which can insert into the flange component and the square groove inside the flexible hand grip. A spring is installed inside the switch button.

Thirdly, this present invention has a spotlight unit at the end of the flexible hand grip. The spotlight unit can rotate around the end of the hand grip and connect to the power circuit device.

Fourthly, this present invention has a cold-cathode light unit in the flexible hand grip that connects to the power circuit device. The cold-cathode light unit consists of a transparent mirror made of transparent materials and a cold-cathode fluorescent tube.

Therefore, the present invention has many alternative independent light sources and hand grip. The flexible hand grip makes relative movements around the illuminant, and serves as a handling device for the user when it falls on the same horizontal line with the illuminant, and it serves as an alternative handling device and support when it is perpendicular to the illuminant. The aforesaid independent sources are installed as follows: the first source, that is, the spotlight unit, is installed in the front end of the illuminant; this super-power source lights up to 5000 meters distance, and finds it use mainly in long-distance lighting and search. The second source, that is, the SOS warning flashlight unit, is installed in the rear end of the illuminant; this SOS warning flashlight can flash for as long as 300 continuous hours and provide constant SOS signaling service for the user. The third source, that is, the small spotlight unit, is installed in the rear end of the flexible hand grip and can provide continuous light for as long as 220 hours, especially ideal for environment and occasions where intensity rather than the duration of the light is important. The fourth source is a cold-cathode unit that is connected to the top of the middle hand grip in a flexible manner. It consists of a cold-cathode fluorescent tube that stands 15,000 hours of continuous use, and is especially suitable for short-distance lighting that simulates sunlight. The aforesaid third source also makes relative movements around the end of the flexible hand grip while the latter rotates around the illuminant. The user may regulate the movement of the flexible hand grip between the vertical or parallel levels in contrast to the illuminant, and stay at any angle for the optimal lighting angle.

Therefore, the present invention is an environmental and energy-saving new-tech structural product that is convenient for search of targets or multi-angle lighting and especially effective for high-risk workers such as policemen, firefighters and army, and is a must-have lighting tool for night battle and chase of suspects.

### BRIEF DESCRIPTION OF SAID DRAWINGS

FIG. 1 is a side view of the present invention;

FIG. 2 is a side sectional view thereof;

FIG. 3 is an underneath view thereof;

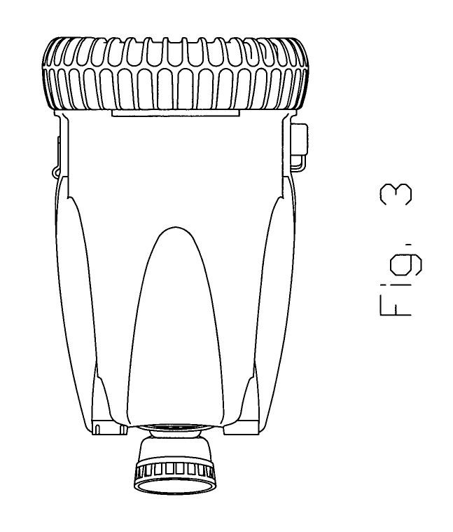

FIG. 4 is a plan view thereof;

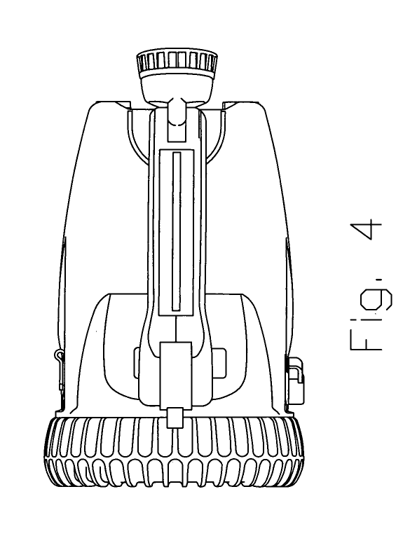

FIG. 5 is a front view thereof;

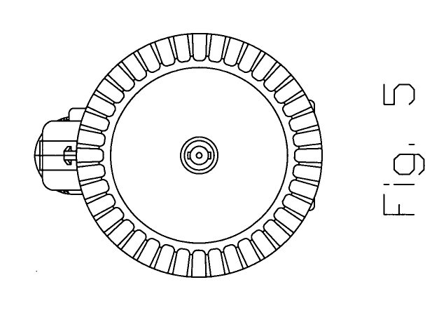

FIG. 6 is a rear view thereof;

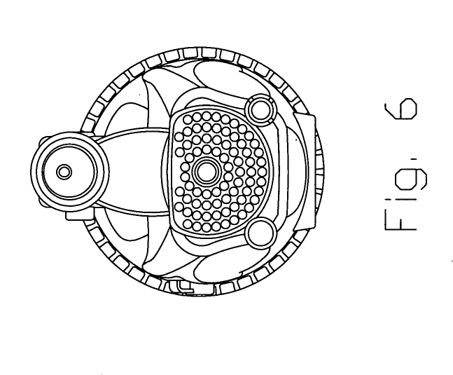

FIG. 7 is another side view thereof;

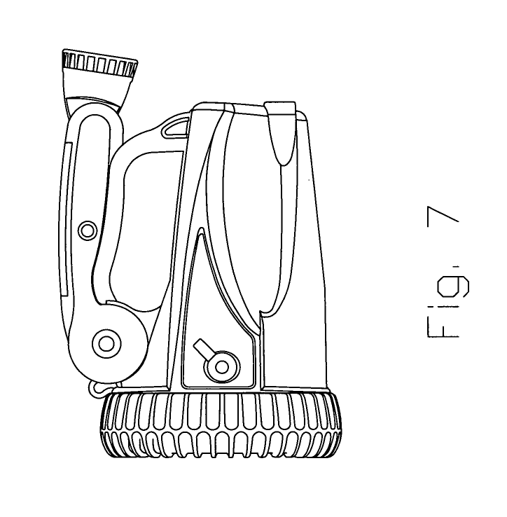

FIG. 8 is a side view showing a grip can be rotated thereof;

FIG. 9 is a side view showing a light on said grip can be rotated thereof;

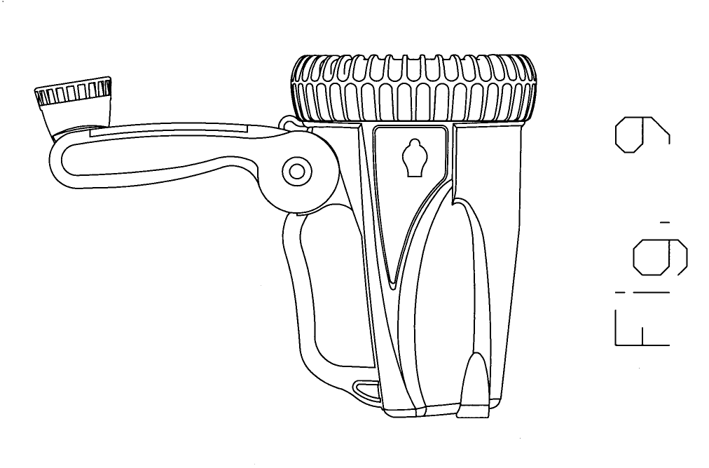

FIG. 10 is a front isometric view thereof;

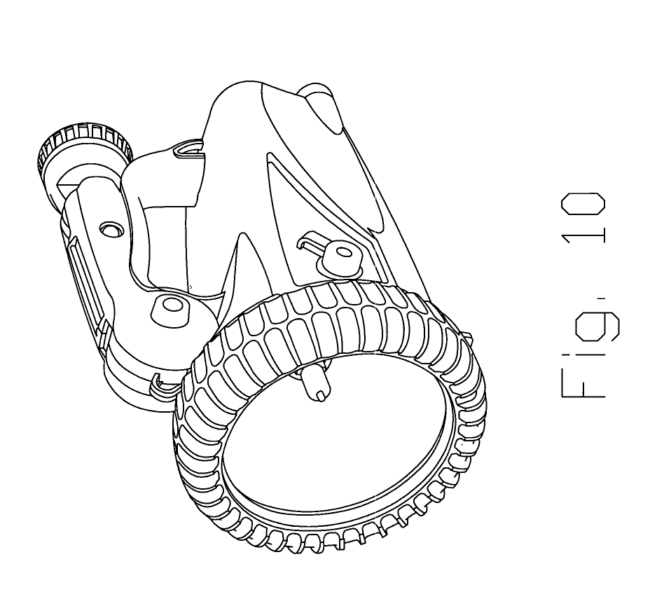

FIG. 11 is a front isometric view with grip and light showing, thereof;

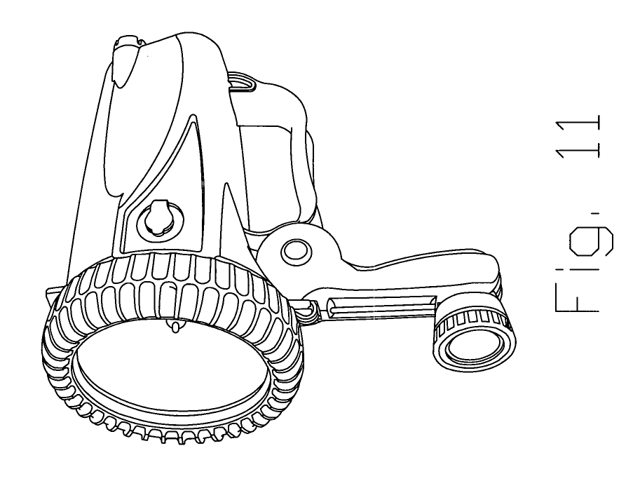

FIG. 12 is a rear isometric view thereof;

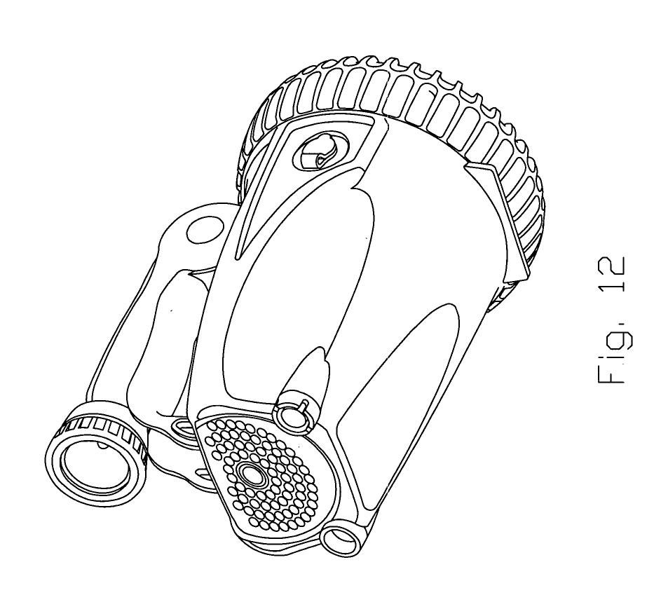

FIG. 13 is an assembly view thereof;

FIG. 14 is an assembly view for said grip and light thereof;

FIG. 15 is an assembly view for a ratable join for said grip thereof.

### DETAILED DESCRIPTION OF SAID PREFERRED EMBODIMENT

As illustrated in all figures various views of present invention is provided.

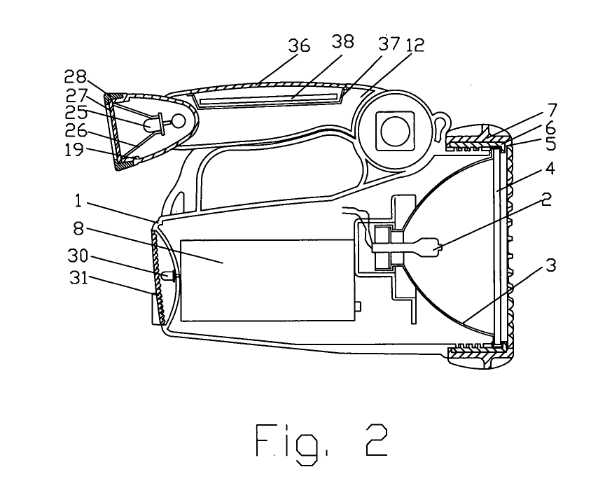

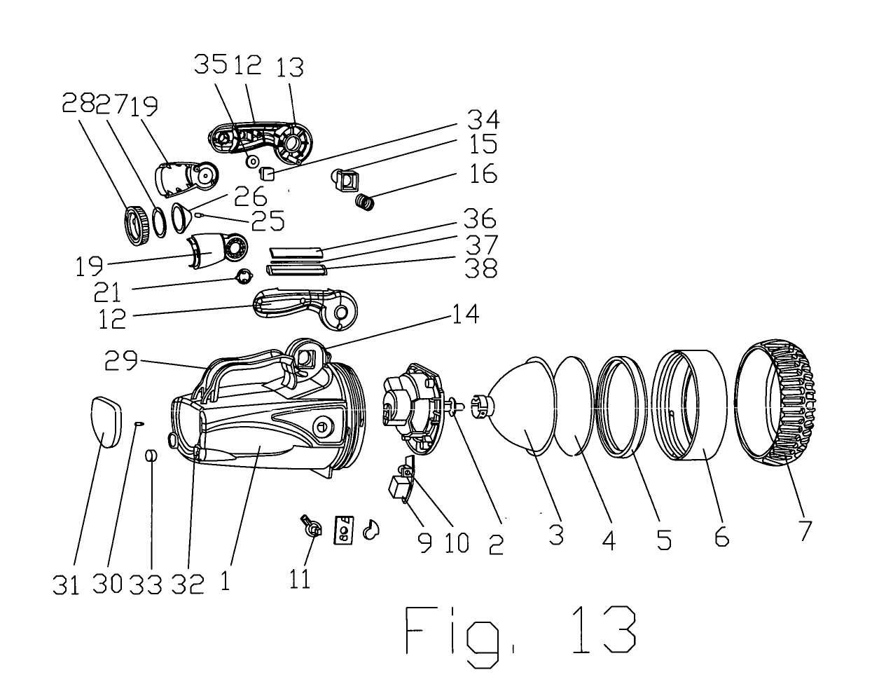

Referring to FIG. 2 and FIG. 13, the present invention of a researchable halogen Searcheye comprises of three-dimensional rectangular-cylinder housing, an illuminant (1), within which there is an inside chamber, one end of said inside chamber installs a spotlight unit, comprise of a light source (2), a parabola-shaped reflector (3) and a transparent front panel (4). A sealing washer (5) seals up a inner side of said front panel (4) and said surface of said reflector (3) within a annular head (6). Said annular head (6) has a cover (7) made of flexible materials on its outer surface, and is fastened to a front end of said illuminant (1) in a dismantling manner. At end portion of said illuminant (1), there is a vent (32), on which there is a ventilation cover (33) made of flexible materials and capable of sealing up said vent (32). Said vent (32) enables heat pressure generated from the inside of said housing to exhaust, and said ventilation cover (33) prevents water from getting into said illuminant (1).

A light source (2) can light up to 5000 meters and comprises of a super-power bulb, which is powered by a light source (8) within said illuminant (1). Said source (8) is connected to a power circuit device (9) within said illuminant (1) through a power line. Both receptor (10) and switch button (11) are connected to said bulb. It is obvious that the source is powered by ordinary or charging battery, or directly by external power supply through external power socket.

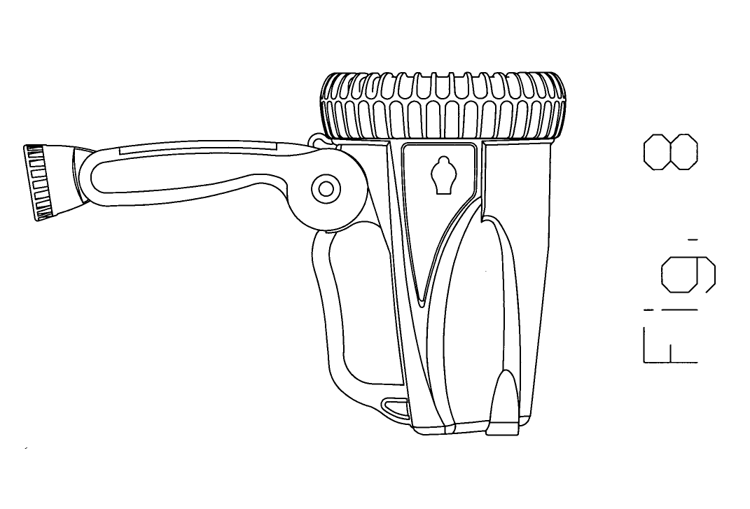

A flexible hand grip (12) is connected to said illuminant (1) through a flange component (14). Said hand grip (12) is usually shaped in rectangular cylinder or cylinder for the convenience of holding. On one end of the hand grip, there is a cylinder joint axle (13), which connects to said flange (14) pivot that is fastened to the external sphere of said illuminant (1), and rotates around said flange component (14). Said flange component (14) has a rectangular cylinder switch hand grip (15) at its end. A spring system (16) is installed inside said switch hand grip (15). Said illuminant (1) has a hand grip (29) in a shaped of a reversed U, and is fastened to said illuminant (1) by both ends. In practice, said hand grip (12) is in position one right next to an up surface of said hand grip (29). As shown in FIG. 8, said hand grip (12) is in position two when its axel becomes almost perpendicular to an axle of said illuminant (1) after leaving a surface of said hand grip (29) and rotates for 13 rounds around a joint axle.

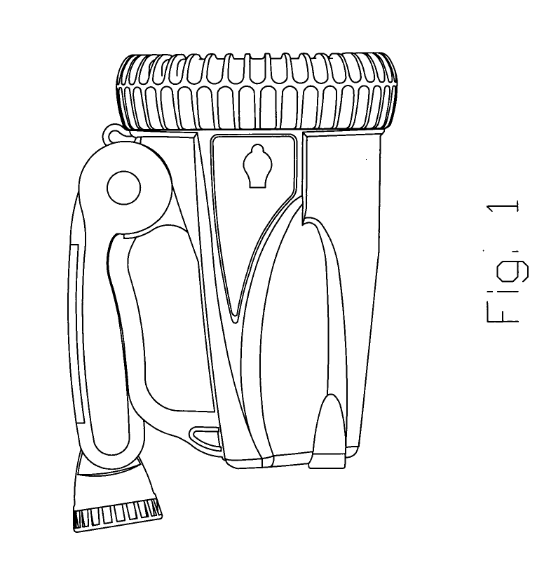

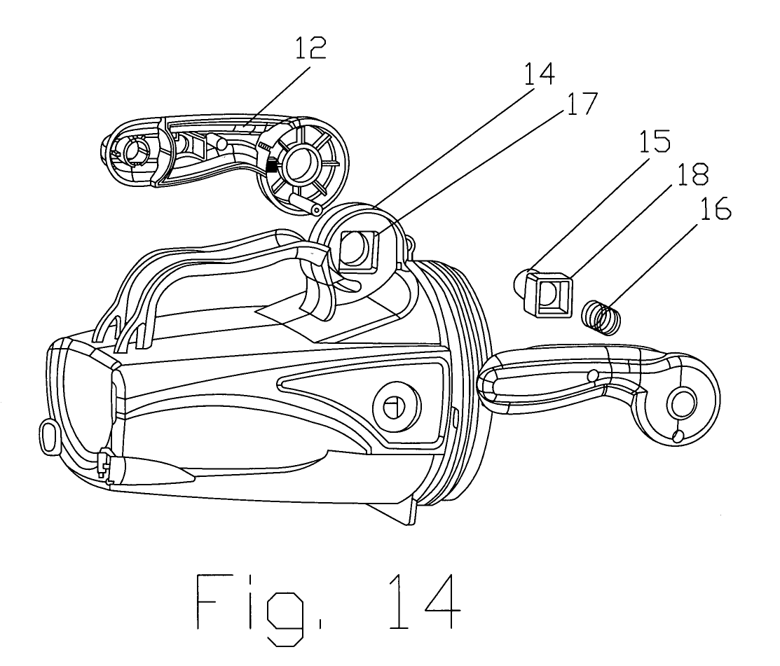

In this new practical invention, said hand grip (12) moves to and stay at any angle between position one and position two as indicated in FIG. 1 and FIG. 8. Referring to FIG. 14, a square pivot arm (18) of said switch hand grip (15) insert into a square groove (17) on one end of said flange component (14), and into another square groove on an inner side of said hand grip (12) by its other end, when said hand grip (12) stops at a position that is relatively steady to said flange component (14). Thus said hand grip (12) is fastened to position one. When said switch hand grip (15) is pressed down under outside force, said pivot arm (18) of said switch hand grip (15) leaves said square groove (17) of said flange component (14), and then said hand grip (12) can move freely or move from position one to position two. Meanwhile, as outside force disappears, a spring (16) inside said switch hand grip (15) helps push back said switch hand grip (15), and push said pivot arm (18) of said switch hand grip (15) back into said square groove (17) of said flange (14), then said hand grip (12) can not make further movements but fastens to position two. Another switch hand grip (34) and a cover (35) made of flexible materials lies inside of said hand grip (12).

A second light source is an SOS signal flashlight unit that provides continuous SOS signal flashlight for 300 hours. Said unit is located in a center bottom portion of said illuminant (1) and connected to a power circuit device. On a bottom portion of said illuminant (1), there is a transparent light shade (31). There is a super-power bulb (30) inside said shade (31). Said shade (31) may come in different colors. When user produces SOS signals, said super-power bulb (30) can produce continuous flashing SOS or warning signals for

200 hours.

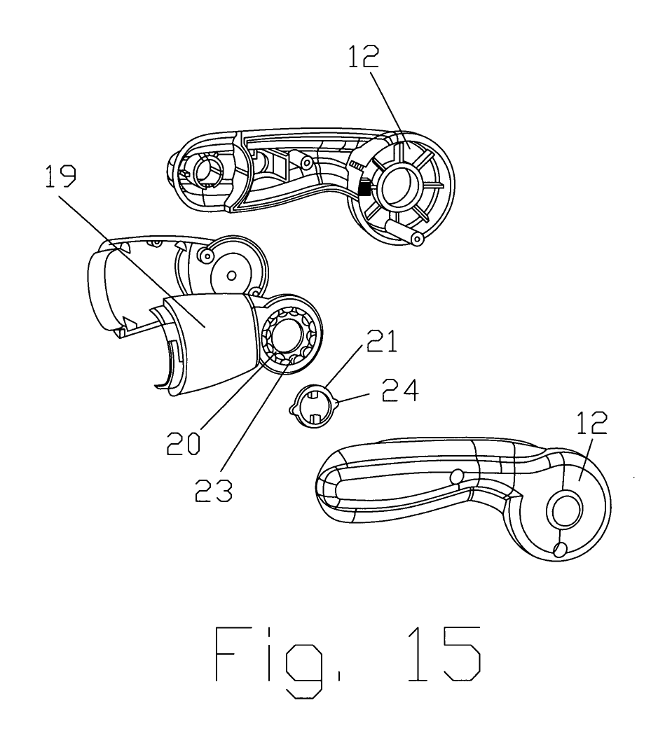

A third source (19), is a second spotlight unit, which connects to a bottom end portion of said hand grip (12) and rotates around said hand grip (12). Referring to FIG. 15, a movable joint coupling (20) is fastened to one end of said third source (19). A flexible annular stationary guide (21) is fastened to an inside of said joint axle (22) in said hand grip (12). Said joint axle (22) of said hand grip (12) and said annular stationary guide (21) can swirled into a gear tooth of said movable joint coupling (20). From an external sphere of said stationary guide (21) extends at least one contacting gear (24) for alternative contact with many gear teeth (23) to fasten a position of said third source (19) in contrast with said hand grip (12). Said gear teeth (23) are evenly distributed on an external sphere of said annular stationary guide (21). Said moveable joint coupling (20) enables connection of said third source (19) by connecting said joint axle (22) to said hand grip (12) and rotation around said joint axle (22), so as to adjust a folding angle between said third source (19) and said hand grip (12). Thus, said third source (19) provides adjustable angle in contrast with said hand grip (12) for continuous lighting up to 220 hours.

Said third source (19) prefers cylinder structure, and consists of a bulb (25), a parabola-shaped reflecting mirror (26), and a transparent front panel (27). A sealing washer annular head (28) is used to seal up said front panel (27) and said reflecting mirror (26). Said annular head (28) fastened to said front end of said third source (19).

A fourth light source (38) is located above said hand grip (12). A cold-cathode light consists of a transparent mirror (36). Said light source (38) is fastened to a tube frame (37). Said cold-cathode fluorescent tube lasts 15,000 hours of usage in indoor or outdoor short-distance lighting.

Said four light sources are independently operating and can emit lights simultaneously or separately.

As illustrated in FIG. 1, when said hand grip (12) is at position one, this new practical invention may be used as flashlight, easy and convenient for hand-held. As i illustrated in FIG. 8, when said hand grip (12) is at position two, this new practical invention is also a flashlight, especially easy for search of targets or multi-angle lighting, and has proved effective for high-risk workers such as policemen, firefighter and soldiers.

On end portion of said hand grip (12) of this rechargeable halogen searcheye, there is a third source (19) that can adjust angles for convenience of users of spotlight who can not hold by hands yet need sufficient source of light, when they can invert said illuminant 91) as illustrated in FIG. 8 to enable said third source (19) to stand on a supporting surface such as table or ground to support said illuminant (1), or to rotate said third source (19) so as to provide users with two sources for simultaneous lighting purpose.

What is claimed is:

1. A rechargeable halogen search light comprises:
a three-dimensional rectangular-cylinder housing, inside of it contains at least four sources of lighting wherein one of said sources of lighting is a spotlight, power saving illuminants; and
one of said sources of lights is a SOS flashlight source, and
one of said sources of lights is another spotlight, and
one of said source of lights is a cold-cathode light, and
a plurality of reflector is fixed around said mean of light source; and
a transparent front flat board; and
a plurality of heat release covers attached at the end portion of said housing; and
a sealed packing collar is connecting a inner portion of said transparent front flat board
and said reflector which resides inside of an annular nut, said annular nut providing a fixed position and a disassembled position on front portion of said housing. Surface of said annular nut, which is located in front of said housing, set an annular shockproof nut; and,
a plurality of an movable handle with a pre-determined adjustable degree mobility, which can provide an ability to rotate and/or to move any angles within 90 degree circular arc so as to provide the best angle of lighting according to appropriated situation.

2. A rechargeable halogen search light as recited in claim 1, wherein, said rechargeable halogen search light is further comprises: at least four light sources, and
at least one arc shaped reflector,
at least one set of main switch,
at least one power receptacle for external electricity,
at least one transformer, and
at least one set of circuitry and power supply.

3. A rechargeable halogen search light as recited in claim 1, wherein said search light has a rotating and clipping device consists of a joint axle at the end of the flexible hand grip, a flange component on the outside of said illuminant, and a switch hand grip. Said joint axle connects said flexible hand grip with said flange component and rotates around said flange. There is a square groove at one end of said flange, and another square groove of similar size inside said flexible hand grip in contrast with a former groove. Said switch hand grip has a square pivot arm, which can insert into said flange component and said square groove inside said flexible hand grip. A spring is installed inside a switch hand grip.

4. A rechargeable halogen search light as recited in claim 1, wherein said rechargeable halogen search light is a light, further comprising: a light housing to which said arc lamp is stationary mounted; a reflector housing to which said reflector is mounted; a reflector positioner comprising a threaded coupling between said light housing and said reflector housing enabling longitudinal displacement of said reflector relative to said light housing by said user manipulation; and a fluted heat sink mounted on said light housing, wherein said housing conductively dissipates lamp heat from said anode.

5. A rechargeable halogen search light as recited in claim 1, wherein said rechargeable halogen search light comprises a cold-cathode light unit in the flexible hand grip that connects with the power circuit device. The cold-cathode light unit consists of a transparent mirror made of transparent materials and a cold-cathode fluorescent tube.

6. A rechargeable halogen search light as recite in claim 1, wherein a rechargeable halogen search light further comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said rechargeable halogen lantern from shocks or quakes when excessive external force applied to it, and
a movable grip wherein there is a chamber inside and at an end portion of said grip, there is at least one source with an adjustable light cap, which can provide different positions.

8. A rechargeable halogen search light as recited in claim 1, wherein said rechargeable halogen search light further comprises:
a handle in a rectangular shape is longitudinally attached to said housing. A front and rear of the handle are equipped with stripes so as to provide a mean of carrying.

9. A rechargeable halogen search light as recited in claim 1, wherein said rechargeable halogen search light further comprises:
a heat release cover is located at rear portion of said housing. Metal screws tightly locked a heat release cover to the rear bump of said housing. A seal packing collar fastens the light fixture's rear inside with a front end of said heat release cover. Said heat release cover provides disassembling position or a fixed position at rear portion of said housing. Batteries can be changed when said heat release cover and said housing are separated. Surface of said heat release cover contains a rubber or soft material made sealing nut. There is a lid on said sealing nut that can seal the entrance of said external receptacle, thus prevent water and is more durable.

10. A rechargeable halogen search light as recited in claim 1, wherein said rechargeable halogen search light having a flexible vent at an end portion of said illuminant(1) as a cover.
